(19) United States
(12) Patent Application Publication
(10) Pub. No.: US 2012/0306193 A1
(43) Pub. Date: Dec. 6, 2012

(54) COMBINATION COUPLING

(76) Inventor: William C. Frazier, Muskego, WI (US)

(21) Appl. No.: 13/485,011

(22) Filed: May 31, 2012

Related U.S. Application Data
(60) Provisional application No. 61/492,198, filed on Jun. 1, 2011.

(51) Int. Cl. F16L 55/00

(52) U.S. Cl. 285/119

(57) ABSTRACT

Disclosed is a combination coupling device having a cylindrical coupling element and a removable bearing hub spider that fits within the coupling element. The coupling element has a coupling ledge on which the bearing hub spider can be positioned and engaged via engagement means. The inner wall of the coupling element may be threaded to engage the ends of complementary threads on pipes inserted therein. The bearing hub spider is interchangeable so as to allow replacement of one bearing hub spider that is specific to a certain application with a second bearing hub spider specific to a different application, without the need to replace the coupling element which can remain in place on the pipe.

### RELATED APPLICATIONS

This application claims the benefit of U.S. Provisional Patent Application Ser. No. 61/492,198 entitled “Combination Coupling” filed Jun. 1, 2011.

### BACKGROUND OF THE INVENTION

The present invention relates generally to combination couplings which are used to join threaded pipe integral with vertical line shaft turbine pumps, and particularly to an improved combination coupling design that utilizes removable bearing hub spiders that fit within a recess of a coupling, and are capable of being interchanged to accommodate bearings of various sizes and lubrication types, such as water lubricated bearings or rubber bushings for oil lubricated application. The present invention also relates to combination couplings that provide improved positioning capabilities over the line shaft.

Present combination coupling designs require that the line shaft be threaded through the bearing or bushing while the coupling device is suspended 5-25 feet in the air. This is not only difficult and inconvenient, but heightens the risk of potential damage to the coupling and/or bearings as well as creates a potentially hazardous situation for the installing personnel.

In addition, previous designs would require complete replacement of the coupling mechanism when, for example, an installation requires larger line shafting and/or bearings, or requires a change between water lubricated or oil lubricated vertical line shaft turbine pump pipe column assembly applications, or when damage occurs to the bearing.

As such, there is a need for a combination coupling design for which the bearing hub can be easily placed on the lineshaft, and can be easily and efficiently interchanged while the body of the coupling stays in place and is reused. The new combination coupling retains the efficient flow characteristics and coupling rigidity of that provided by previous combination coupling designs, as well as provides the ideal center-to-center accuracy of lineshaft bearings and bushings.

### SUMMARY OF THE INVENTION

The present invention provides a combination coupling device that satisfies those needs.

One aspect of the invention provides a combination coupling device comprising a cylindrical coupling element having an upper end for receiving a first pipe end, a lower end for receiving a second pipe end, and an inner wall; wherein the coupling element further comprises a coupling ledge, extending from the inner wall, the ledge having an upper ledge surface, a lower ledge surface, and an inner-facing ledge surface; and wherein the coupling element further comprises a first threaded portion to engage with a threaded portion on the first pipe, and a second threaded portion to engage with a threaded portion on the second pipe, the first and second threaded portions formed in the inner wall, around the circumference of the coupling element. The combination coupling device may further comprise a bearing hub spider comprising an outer ring, a bearing hub, and a plurality of spokes extending from the bearing hub to the outer ring, wherein the bearing hub spider is sized and configured to fit within the coupling element and sit on the coupling ledge upper ledge surface, and engagement means for engaging the coupling element with the bearing hub spider.

The device may include engagement means taking the form of at least one engagement pin extending from one of the outer ring of the bearing hub spider and the coupling ledge to be received by a correspondingly positioned aperture on the other of the outer ring and the coupling ledge.

The device may include at least one engagement pin extending from a lower surface of the outer ring of the bearing hub spider to be received by an aperture formed in the upper surface of the coupling ledge.

The device may include at least one engagement pin being positioned within an aperture formed in one of the outer ring of the bearing hub spider and the coupling ledge, and extends therefrom.

The device may include three engagement pins extending from the outer ring and positioned in three apertures formed in the outer ring, to be received by three correspondingly positioned apertures in the coupling ledge.

The device may include the three engagement pins being spaced 120-degrees apart along the outer ring and the three engagement apertures are spaced 120-degrees apart along the coupling ledge.

The device may include the bearing hub spider having three spokes.

All edges of the device may be rounded.

The device may be designed such that the ends of the spokes of the bearing hub spider are filleted where the spokes meet the bearing hub and the outer ring.

The device may include the coupling ledge extending from the inner wall of the coupling element at a position substantially equidistant between the top end and the bottom end.

The device may include the coupling ledge inner-facing surface being sloped from the upper ledge surface to the lower ledge surface.

The device may include the inner wall of the coupling element having a diameter that is no more than 0.010 inches greater than an outer diameter of the outer ring of the hub bearing spider.

The device may include the bearing hub of the bearing hub spider having an inner diameter that corresponds to the outer diameter of a bearing to be used.

The device may include the bearing hub inner diameter being no more than 0.060 inches greater than the outer diameter of the bearing to be used.

Another aspect of the invention provides a combination coupling device comprising a cylindrical coupling element having an upper end for receiving a first pipe end, a lower end for receiving a second pipe end, and an inner wall; wherein the coupling element further comprises a coupling ledge, extending from the inner wall, the ledge having an upper ledge surface, a lower ledge surface, and an inner-facing ledge surface; and wherein the coupling element further comprises a first threaded portion to engage with a threaded portion on the first pipe, and a second threaded portion to engage with a threaded portion on the second pipe, the first and second threaded portions formed in the inner wall, around the circumference of the coupling element. The combination coupling device may further comprise a removable spider element comprising an outer ring and a plurality of spokes extending from the center of the spider element to the outer ring, wherein the spider element is sized and configured to fit within the coupling element and sit on the coupling ledge upper ledge surface, and engagement means for engaging the coupling element with the bearing hub spider.

### BRIEF DESCRIPTION OF THE DRAWINGS

FIG. 1 is an exploded perspective view of a combination coupling according to the present invention.

FIG. 2 is a perspective view of a combination coupling according to the present invention.

FIG. 3 is a cross-sectional view of a coupling element according to the present invention along the line 3-3 of FIG. 4.

FIG. 4 is a top view of a coupling element according to the present invention.

FIG. 5 is a bottom view of a bearing hub spider according to the present invention.

FIG. 6A is a cross-sectional view of a spoke of a bearing hub spider according to the present invention along line 6A of FIG. 5.

FIG. 6B is a cross-sectional view of a spoke of a bearing hub spider according to the present invention along line 6B of FIG. 5.

FIG. 6C is a cross-sectional view of a spoke of a bearing hub spider according to the present invention along line 6C of FIG. 5.

FIG. 7 is a cross-sectional view of a bearing hub spider according to the present invention along line 7-7 of FIG. 5.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

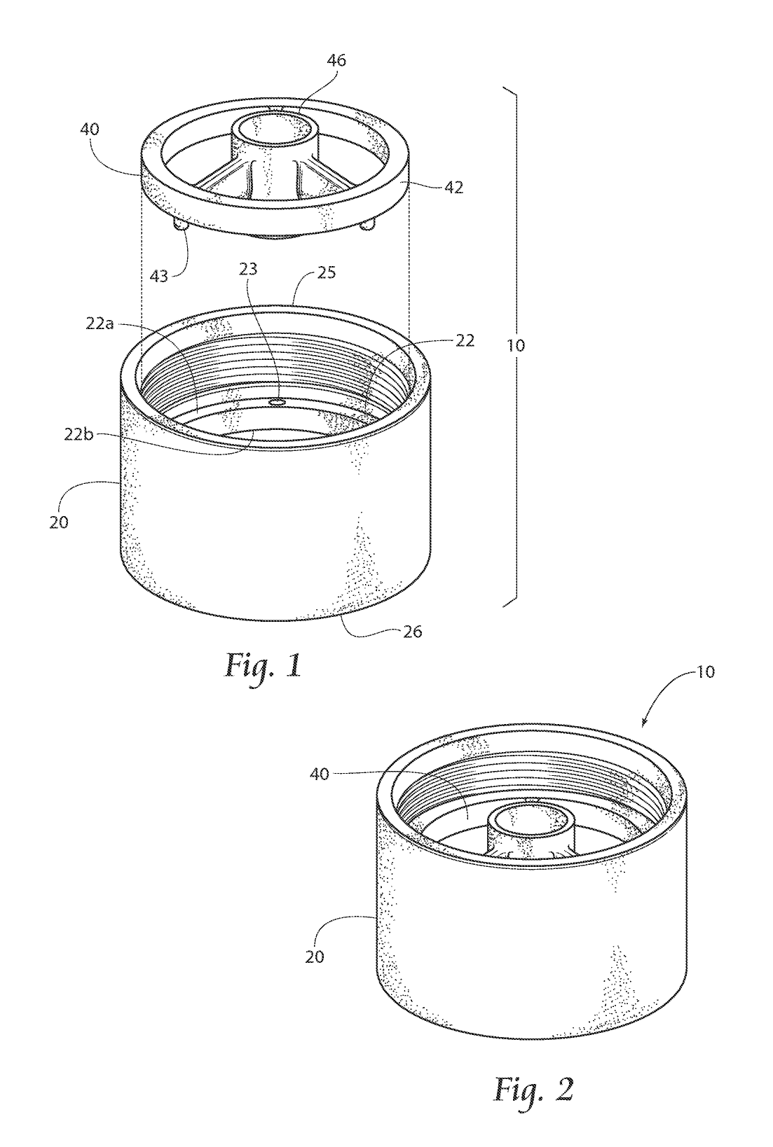

FIG. 1 shows the combination coupling 10 according to the present invention having a coupling element 20 and a removable bearing hub spider 40. As depicted in FIGS. 1 and 2, the hub spider 40 is sized and configured to fit within the coupling 20 and sit upon a coupling ledge 22.

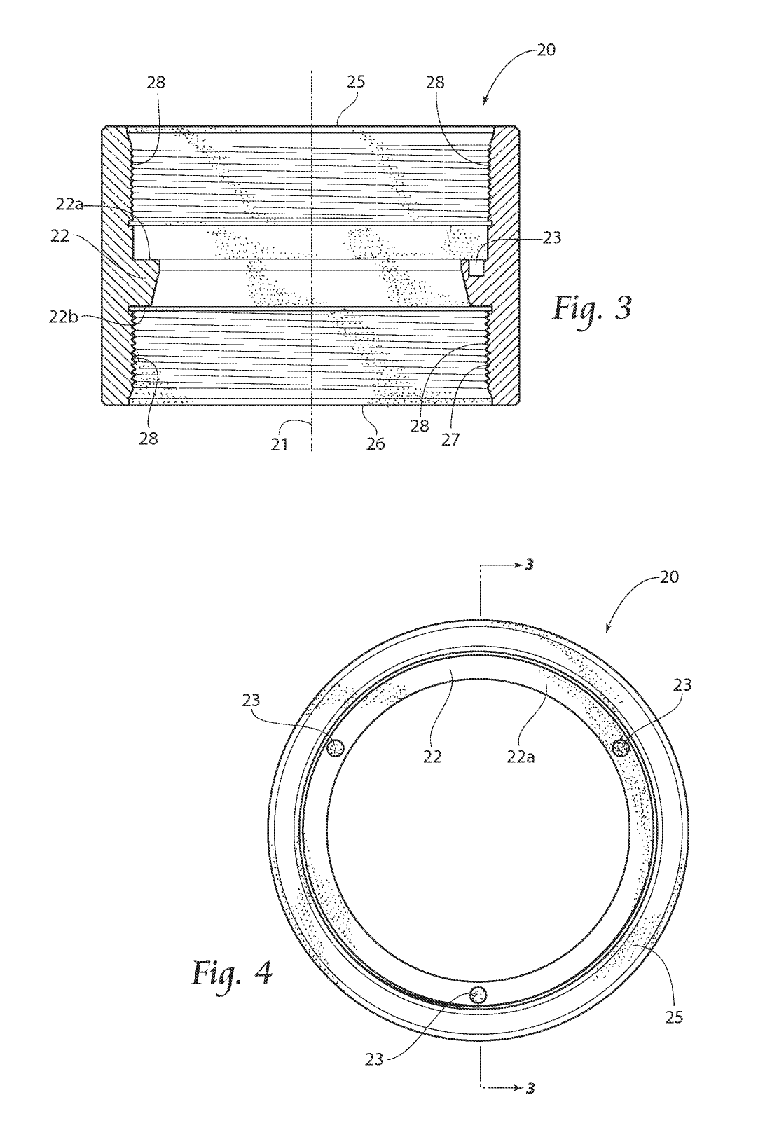

As shown in FIGS. 3 and 4, the coupling element 20 of the present invention comprises a cylindrical body portion 24 having a top end 25 and a bottom end 26. The bottom end 26 may be configured for receiving the end of a column pipe (not shown). The column pipe extends into the bottom end 26 of the body portion 24 until the end of the column pipe sits adjacent to the bottom surface 22b of ledge 22. The width of the ledge 22 extending towards the center axis 21 of the coupling element 20 is preferably such that it will accept and substantially cover the entire circumference of the end face of the respective column pipe, which protects the end face of the pipe from corrosion and abrasion during use. Similarly, the circumference of the pipe end face inserted through the top end 25 is also completely covered by the outer ring 42 of the bearing hub spider 40 (described below) to protect the end face of the second column pipe. The inside face 27 of the bottom end 26 of the coupling 20 and the end of the column pipe are preferably configured with complementary threads 28 to accommodate threadable engagement.

The coupling element 20 further comprises a coupling ledge 22 that is adapted to receive the removable bearing hub spider 40. As shown, in a preferred embodiment, the coupling ledge may be located substantially equidistant between the top end 25 and the bottom end 26. The bearing hub spider 40 is positioned on the coupling ledge 22 through the top end 25. The coupling ledge 22 extends laterally into the cylindrical body 24 about the inner diameter of the cylindrical body 24. The coupling ledge 22 may have a plurality of engagement apertures 23 formed in the upper face 22a of the coupling ledge 22 as shown. The engagement apertures 23 are configured to receive engagement pins 43 on the bearing hub spider 40, as discussed below. The engagement apertures 23 may be of any suitable diameter that is capable of accommodating the engagement pins 43 of the spider bearing hub 40. In a preferred embodiment, as shown, the coupling element 20 has three engagement apertures 23 spaced apart at 120 degrees.

Similar to the bottom end 26, the portion of the top end 25 above the coupling ledge 22 may be configured for receiving the end of a second column pipe (not shown). The inside face 27 of the top end 25 of the coupling 20 and the end of the second column pipe are preferably configured with complementary threads 28 to accommodate threadable engagement. In one embodiment, the coupling 20 may be threaded to accept 8 threads per inch column pipe, and threads 28 may have a taper of ⅛″ per foot, but any threads 28 of any appropriate specification may be used to be used with correspondingly configured threads on the pipe.

As shown in FIG. 4, the transition from top machined face surface 22a of the ledge 22 that receives the spider 40 to the bottom surface 22b of the ledge 22 may be sloped to facilitate smooth water flow.

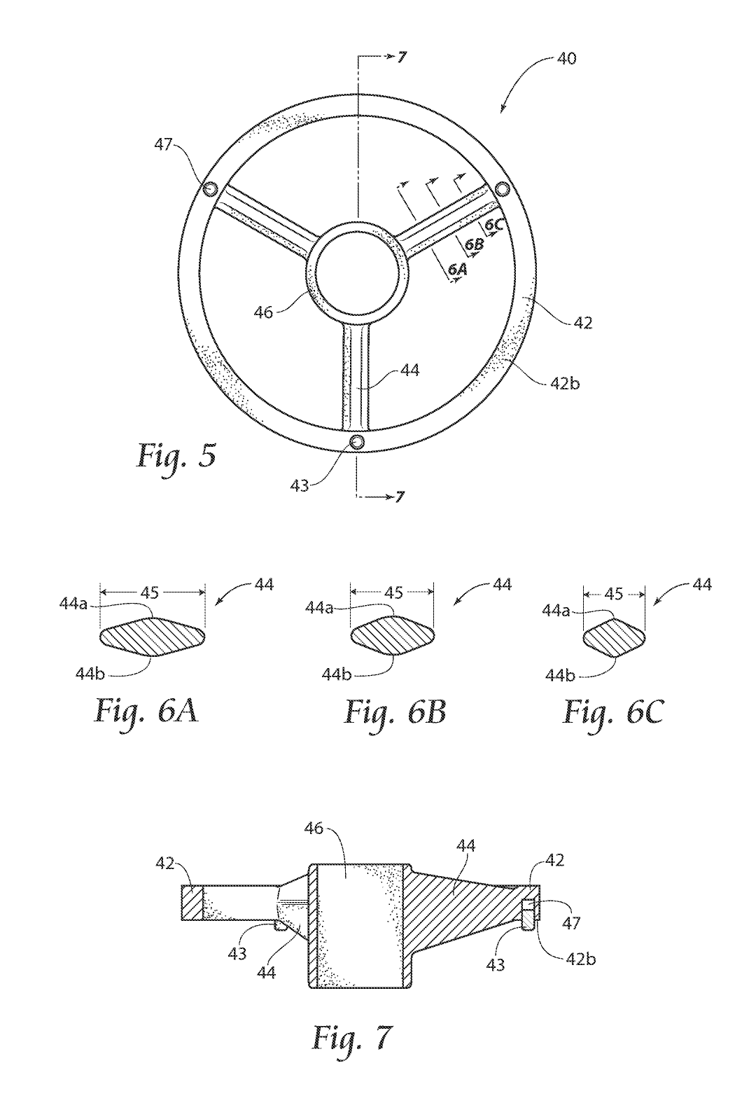

The combination coupling according to the present invention further comprises a bearing hub spider 40 as shown in FIG. 5. As shown, the removable bearing hub spider 40 preferably has an outer ring 42, a plurality of spokes 44, and a center bearing hub 46 for receiving a bearing or rubber bushing (not shown). The outer ring 42 is designed to fit within and associate with the coupling element 20, as mentioned above. Specifically, the bearing hub spider 40 may have a plurality of engagement pins 43 extending from the outer ring 42 that may be received by the apertures 23 formed into the top machined face 22a of the ledge 22 of coupling element 20. The engagement pins 43 are preferably positioned correspondingly to the apertures in the coupling element 20. In a preferred embodiment, as shown, the bearing hub spider 40 has three engagement pins spaced apart at 120 degrees. Preferably, each of the pins 43 may be threadably engaged within a hub aperture 47 formed in the bottom face 42b of the outer ring 42. The aperture 47 is preferably configured such that the engagement pin 43 can be engaged within the aperture 47 such that the engagement pin 43 extends at least partially out from the aperture 47. While this configuration is preferred, any similar configuration of engagement pins 43, such as protrusions formed on the bottom side 42b of the outer ring 42, may be used in accordance with the present invention.

The inner face 27 of the coupling element 20 preferably has a diameter D1 that is slightly larger than the diameter D2 of the outer ring 42. For example, in a preferred embodiment, the diameter D1 of the inner face 27 is no more than 0.010″ greater than the diameter D2 of the outer ring 42. This precise sizing helps to facilitate center of lineshaft to center of lineshaft accuracy, among other advantages.

The bearing hub spider 40 has a plurality of spokes 44. In the embodiment shown, the spider 40 has three spokes 44. The spokes 44 of the removable bearing hub spider 40 are preferably uniform with one another, and preferably have a cross-section having a midpoint width 45 and tapering toward the top 44a and bottom 44b of the spoke 44, making a diamond-like shape, as shown in FIGS. 6A, 6B, and 6C. As also shown in FIGS. 6A, 6B, and 6C, the width 45 of the spokes 44 may decrease as the spoke extends from the center bearing hub 46 to the outer ring 42. Additionally, the spokes 44 may be filleted where they meet the outer ring 42 and the center bearing hub 46. These design features, and others, facilitate positive flow dynamics by reducing friction losses and pressure drops during use.

The center bearing hub 46 of the bearing hub spider 40 is preferably accurately machined to accommodate a specified bearing/bushing (not shown) and bearing/bushing material (not shown). The diameter D3 of the bearing hub 46 is preferably no larger than 0.60″ greater than the outside diameter of the bearing to be used. The typical outside diameters of typical bearings are 2″, 2½″, 2¾″, 3″, and 3½″, and the bearing hub 46 is preferably made to fit the specified individual bearing diameter. As such, the bearing hub spiders 40 can be made having variously sized center bearing hubs 46, while still maintaining the same size and configurations of the other portions of the bearing hub spiders 40 so that the bearing hub spiders 40 are interchangeable for use with the same coupling element 20. The spider hubs 40 for water-lubricated application are preferably designed to accept lineshaft bearings and hold the bearings in place without the use of external collars, lock rings, or adhesives. The bearing hub 46 preferably has a ledge surface 49 for holding the bearing within the bearing hub 46.

In accordance with being designed to facilitate a variety of specific bearings or bushings and bearing or bushing materials, for example, if a graphite or other similar soft material is specified, the hub may be preferably machined for an interference fit as may be recommended by the bearing manufacturer, and the bearing hub may be preferably machined to provide a machined surface for the bearing at the bottom of the hub 40.

It is also contemplated that a hub-less ring may be used with the coupling element 20 for any type of application, such as air lifting, submersible pumps, oil lube column with rubber centering spokes with hub etc, therefore broadening the uses for which the coupling element 20 can be used by merely interchanging the hub 40.

The coupling 20 and removable bearing hub spider 40 may be manufactured of ductile iron, other types of appropriate cast iron, or other suitable material. Of particular importance is a high tensile strength, such that the couplings can be set to virtually any depth. Preferably, the combination coupling according to the present invention may be made of 65-45-12 Ductile Iron having a tensile strength of 65,000 psi. All surfaces of the coupling element and removable bearing hub spider that are subject to fluid flow thereby may be preferably rounded and tapered to facilitate the best possible hydrodynamic design, thereby minimizing friction losses and pressure drop through the coupling. In addition, the design utilizes the maximum possible open area, specifically by the spoked hub design, to keep friction loss and pressure drop to a minimum.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A combination coupling device comprising:
a cylindrical coupling element having an upper end for receiving a first pipe end, a lower end for receiving a second pipe end, and an inner wall;
wherein the coupling element further comprises a coupling ledge, extending from the inner wall, the ledge having an upper ledge surface, a lower ledge surface, and an inner-facing ledge surface;
wherein the coupling element further comprises a first threaded portion to engage with a threaded portion on the first pipe, and a second threaded portion to engage with a threaded portion on the second pipe, the first and second threaded portions formed in the inner wall, around the circumference of the coupling element;
a bearing hub spider comprising an outer ring, a bearing hub, and a plurality of spokes extending from the bearing hub to the outer ring;
wherein the bearing hub spider is sized and configured to fit within the coupling element and sit on the coupling ledge upper ledge surface; and
engagement means for engaging the coupling element with the bearing hub spider.

2. The device according to claim 1 wherein the engagement means comprises at least one engagement pin extending from one of the outer ring of the bearing hub spider and the coupling ledge to be received by a correspondingly positioned aperture on the other of the outer ring and the coupling ledge.

3. The device according to claim 2 wherein the at least one engagement pin extends from a lower surface of the outer ring of the bearing hub spider to be received by an aperture formed in the upper surface of the coupling ledge.

4. The device according to claim 2 wherein the at least one engagement pin is further positioned within an aperture formed in one of the outer ring of the bearing hub spider and the coupling ledge, and extends therefrom.

5. The device according to claim 2 further comprising three engagement pins extending from the outer ring and positioned in three apertures formed in the outer ring, to be received by three correspondingly positioned apertures in the coupling ledge.

6. The device according to claim 5 wherein the three engagement pins are spaced 120-degrees apart along the outer ring and the three engagement apertures are spaced 120-degrees apart along the coupling ledge.

7. The device according to claim 1 wherein the bearing hub spider further comprises three spokes.

8. The device according to claim 1 wherein all edges subject to fluid flow thereby are rounded.

9. The device according to claim 1 wherein the end of the spokes of the bearing hub spider are filleted where the spokes meet the bearing hub and the outer ring.

10. The device according to claim 1 wherein the coupling ledge extends from the inner wall of the coupling element at a position substantially equidistant between the top end and the bottom end.

11. The device according to claim 1 wherein the coupling ledge inner-facing surface is sloped from the upper ledge surface to the lower ledge surface.

12. The device according to claim 1 wherein the inner wall of the coupling element defines a first diameter and the outer ring of the bearing hub spider defines a second diameter, and wherein the second diameter is smaller than the first diameter.

13. The device according to claim 12 wherein the first diameter is no more than 0.010 inches greater than the second diameter.

14. The device according to claim 1 wherein the bearing hub of the bearing hub spider defines a third diameter and a bearing to be used with the bearing hub defines a fourth diameter, and wherein the third diameter is no more than 0.060 inches greater than the fourth diameter.

15. A combination coupling device comprising:
a cylindrical coupling element having an upper end for receiving a first pipe end, a lower end for receiving a second pipe end, and an inner wall;
wherein the coupling element further comprises a coupling ledge, extending from the inner wall, the ledge having an upper ledge surface, a lower ledge surface, and an inner-facing ledge surface;
wherein the coupling element further comprises a first threaded portion to engage with a threaded portion on the first pipe, and a second threaded portion to engage with a threaded portion on the second pipe, the first and second threaded portions formed in the inner wall, around the circumference of the coupling element;
a spider element comprising an outer ring and a plurality of spokes extending from the center of the spider element to the outer ring;
wherein the spider element is sized and configured to fit within the coupling element and sit on the coupling ledge upper ledge surface; and
engagement means for engaging the coupling element with the spider element.
